(19) United States
(12) Patent Application Publication
(10) Pub. No.: US 2007/0195555 A1
(43) Pub. Date: Aug. 23, 2007

(54) Backlight module and liquid crystal display

(76) Inventors: Wei-Chi Lin, Jhonghe City (TW); Kuo-Liang Chu, Pingjhen City (TW); Yun-Shih Wang, Dasi Township (TW)

Correspondence Address: J.C. Patents, Inc., Suite 250, 4 Venture, Irvine, CA, 92618, US

(21) Appl. No.: 11/358,973

(22) Filed: Feb. 21, 2006

(51) Int. Cl. F21V 7/04

(52) U.S. Cl. 362/633

(57) ABSTRACT

A backlight module having a light source module and an optical film module is provided. The light source module includes a first frame module and a light source. The light source is disposed in the first frame module. The optical film module includes a second frame module and a plurality of optical films. The optical films are disposed in the second frame module. The optical film module is detachably disposed on the light source module.

### BACKGROUND OF THE INVENTION

1. Field of the Invention

The present invention generally relates to a backlight module and a display device, in particular, to a backlight module with increased assembling efficiency and a liquid crystal display having the backlight module.

2. Description of Related Art

The size of visual or image devices becomes smaller in order to adapt to the modern life. Traditional cathode ray tube (CRT) displays are quite bulky owing to the electron chamber structure and may be harmful due to the radiation. Following the developments in optoelectronic technology and the semiconductor fabrication technology, flat panel displays, including liquid crystal display (LCD), organic electroluminescence diode display (OLED) and flat panel display (FPD), have became the key display products in the market.

According to the types of the light source, there are three types of LCD, including reflective LCD, transmissive LCD and transflective LCD. Either the transmissive LCD or the transflective LCD basically consists of a liquid crystal display panel and a backlight module. The liquid crystal display panel includes two transparent substrates and a liquid crystal layer between the two transparent substrates, and the backlight module is used as a flat light source.

FIG. 1 illustrates a three-dimensional exploded view of a traditional backlight module. In FIG. 1, the traditional backlight module 100 mainly consists of a lower frame 110, a reflector 120, a frame 130, a light source 140, another frame 150, a diffusion film 160, a plurality of optical films 170 and an upper frame 180. The reflector 120 is disposed on a bottom surface of the lower frame 110. The light source 140 is disposed on the frame 130. The diffusion film 160 and the optical films 170 are successively disposed on the frame 150. Finally, the upper frame 180 and the lower frame 110 are assembled to put the reflector 120, the diffusion film 160 and the optical films 170 together.

Particularly, the fabrication steps of the backlight module 100 follow the order described below: providing a lower frame 110, disposing a reflector 120, disposing a frame 130, disposing a light source 140, disposing a frame 150, disposing a diffusion film 160, disposing optical films 170 and disposing an upper frame 180, thus completing the assembly of the backlight module 100.

However, all the components of the backlight module 100 in FIG. 1 are integrated together. That is, the diffusion film 160 and the optical films 170 can not be assembled until the light source 140 is assembled. Therefore, the assembling efficiency of the backlight module 100 is adversely affected.

Furthermore, as the light source 140 or one of the optical films 170 is damaged, the backlight module 100 must be disassembled in sequence, in the reverse order of the assembling sequence, to repair the light source 140, the diffusion film 160 or the optical films 170. Therefore, disassembling the backlight module 100 is time-consuming and may easily cause damages to the optical films 170. Moreover, disassembling will increase the possibilities of external particles entering into the optical films 170. In addition, since each component has to be reassembled after repairing, the maintenance efficiency of the traditional backlight module 100 is decreased.

### SUMMARY OF THE INVENTION

Accordingly, one objective of the present invention is to provide a backlight module for preventing the optical films from being damaged and decreasing the possibilities of external particles entering into the optical films, and therefore improve the assembling efficiency and the maintenance efficiency of the backlight module.

Another objective of the present invention is to provide a liquid crystal display having the above backlight module, which has higher assembling efficiency and superior maintenance efficiency.

In order to achieve the above objectives, the present invention provides a backlight module comprising a light source module and an optical film module. The light source module comprises a first frame module and a light source disposed in the first frame module. The optical film module comprises a second frame module and a plurality of optical films disposed in the second frame module. The optical film module is detachably disposed on the light source module.

In order to achieve the above objectives, a liquid crystal display comprising the above backlight module and a liquid crystal display panel disposed on the backlight module is provided.

In one embodiment of the present invention, the first frame module comprises a first frame, a second frame and a first fastener for joining the first frame and the second frame.

In one embodiment of the present invention, the second frame module comprises a third frame, a fourth frame and a second fastener for joining the third frame and the fourth frame.

In one embodiment of the present invention, the backlight module further includes a third fastener for joining the light source module and the optical films module.

In one embodiment of the present invention, the light source module further includes a reflector disposed in the first frame module and at the backside of the light source.

In one embodiment of the present invention, the light source is selected from the group consisting of the cold cathode fluorescent lamp (CCFL), the external electrode fluorescent lamp (EEFL), the light emitting diode (LED) and the flat fluorescent lamp (FFL) and the combination thereof.

In one embodiment of the present invention, the optical films are selected from the group consisting of diffusion films, prism sheets, brightness enhancement films and the combination thereof.

In one embodiment of the present invention, the first frame module and the second frame module are made of plastics, metals or the combination thereof.

In one embodiment of the present invention, the liquid crystal display further includes an outer frame for joining the backlight module with the liquid crystal display panel.

The present invention employs independent light source module and optical film module, so that the light source module and the optical film module are detachably joined. Therefore, either the light source module or the optical film module is broken, only the broken one needs to be disassembled. Because not all components of the backlight module have to be disassembled in sequence during repairing the possibilities of the optical films being damaged and external particles entering into the optical films are reduced. Since the light source module or the optical film module is independently assembled or repaired, the assembling and maintenance efficiency of the backlight module is improved.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 illustrates a three-dimensional exploded view of a traditional backlight module.

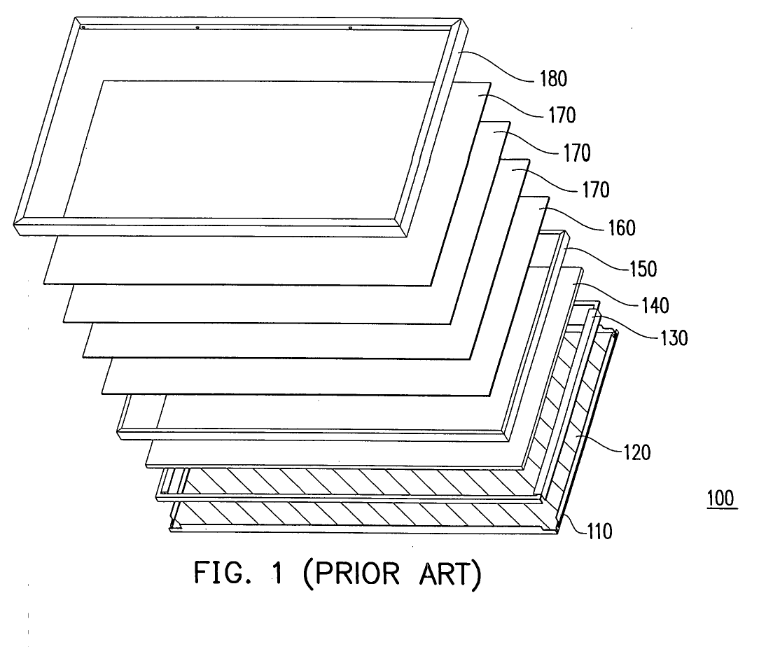

FIG. 2 is an exploded view of a backlight module according to a preferred embodiment of the present invention.

FIG. 3A is a three-dimensional diagram of the assembled first frame module according to a preferred embodiment of the present invention.

FIG. 3B is a three-dimensional diagram of the assembled second frame module according to a preferred embodiment of the present invention.

FIG. 4 is a schematic view of a liquid crystal display according to a preferred embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the descriptions to refer to the same or like parts.

The backlight module comprises an independent light source module and an independent optical film module. The light source module and the optical film module are independently assembled and/or repaired, such that the assembling efficiency and the maintenance efficiency of the backlight module are increased. Thereinafter, embodiments are recited to describe the backlight module of the present invention in further details.

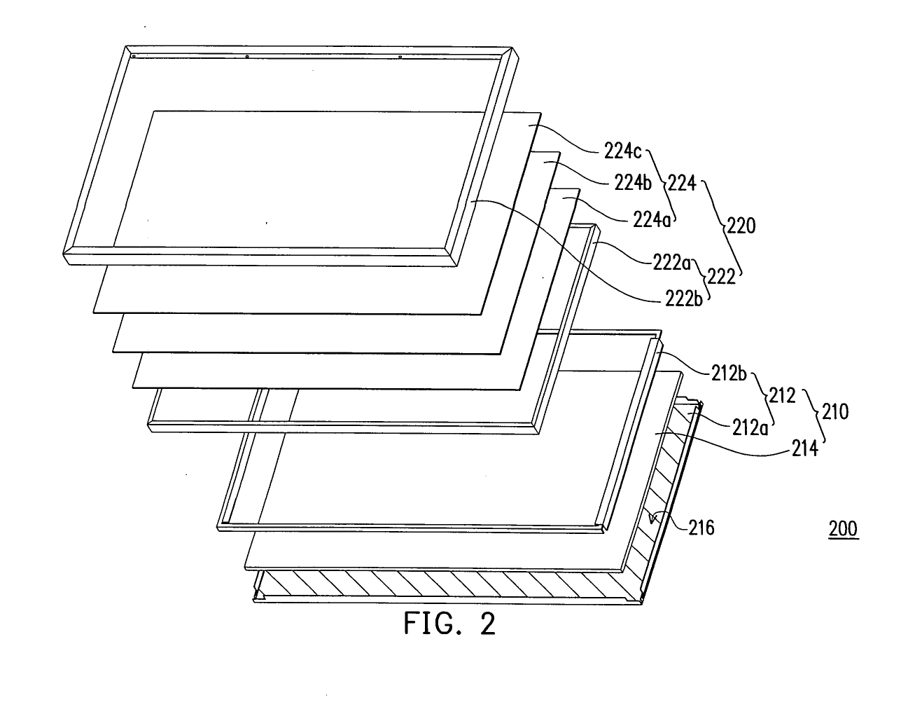

FIG. 2 is an exploded view of a backlight module according to a preferred embodiment of the present invention. In FIG. 2, the backlight module 200 comprises a light source module 210 and an optical film module 220. The light source module 210 includes a first frame module 212 and a light source 214. The light source 214 is disposed in the first frame module 212. The optical film module 220 includes a second frame module 222 and a plurality of optical films 224 disposed in the second frame module 222. The optical film module 220 and the light source module 210 are independent units, and the optical film module 220 is detachably disposed on the light source module 210.

In one embodiment of the present invention, the light source 214 in the light source module 210 is a cold cathode fluorescent lamp, an external electrode fluorescent lamp, a light emitting diode or a flat fluorescent lamp. The light source 214 can be any kind of flat or planar lamps. The light source 214 of the present invention is not restricted to the listed types of light sources. Moreover, the light source module 210 includes a reflector 216 disposed in the first frame module 212 and on the back of the light source 214. The reflector 216, of a high reflectivity, reflects the light from the light source 214 to improve the efficiency of the light source 214.

In FIG. 2, the optical films 224 in the optical film module 220 can be diffusion films 224a, prism sheets 224b or brightness enhancement films 224c or the combination thereof. The type and the number of the optical films 224 are varied in accordance with the actual demands. That is, the type and the number of the optical films 224 are not limited to the descriptions in the present invention. Furthermore, the material of the first frame module 212 and the material of the second frame module 222 can be independently plastics or metals or the combination thereof. More specifically, since the light source 214 generates heat, the material of the first frame module 212 can be a metal with better thermal dissipation, for example. Since the optical film module 220 has no concerns about heat dissipation, the second frame module 222 can be made of plastics, for example.

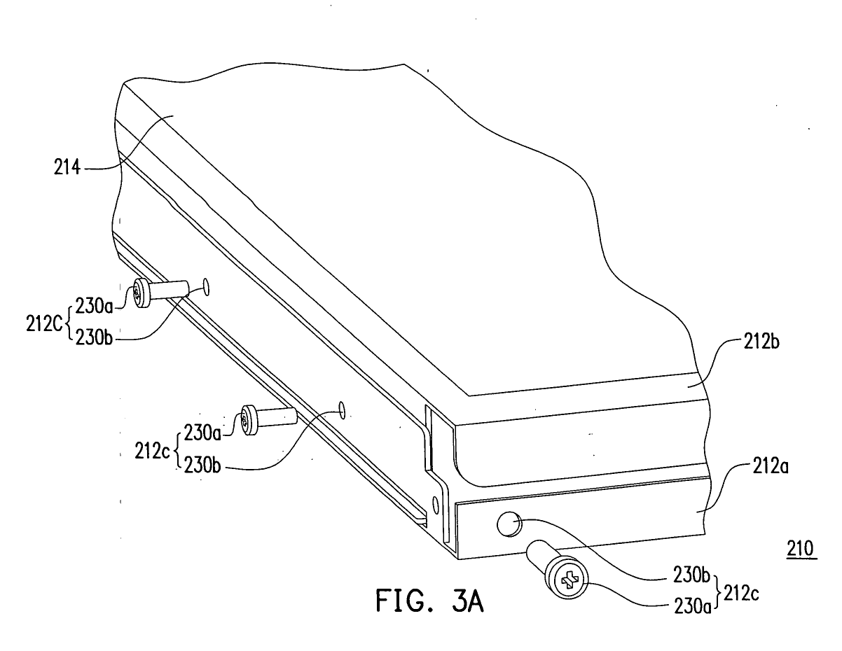

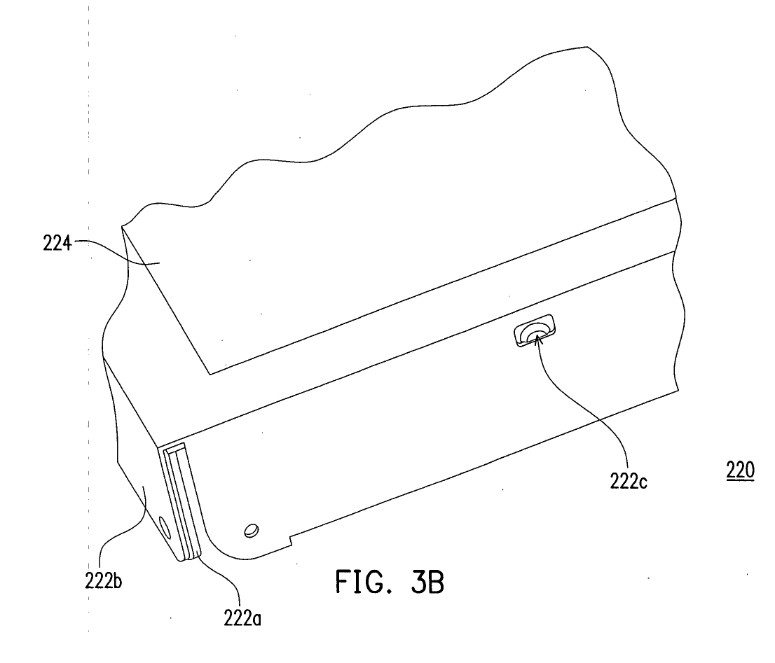

It should be noted that the light source module 210 and the optical film module 220 are individual units through the utilization of the first frame module 212 and the second frame module 222. In one embodiment, the first frame module 212 as shown in FIG. 2 includes a first frame 212a, a second frame 212b and a first fastener 212c shown in FIG. 3A. The first frame 212a is assembled to the second frame 212b by the first fastener 212c. Furthermore, the second frame module 222 as shown in FIG. 2 includes a third frame 222a, a fourth frame 222b and a second fastener 222c (shown in FIG. 3) to assemble the third frame 222a with the fourth frame 222b.

FIG. 3A is a three-dimensional diagram of the assembled first frame module according to a preferred embodiment of the present invention. In FIG. 3A, the first frame module 210 uses the first fastener 212c to join the first frame 212a with the second frame 212b and to fix the light source 214 to the first frame module 210. In one embodiment of the present invention, the joining mechanism of the first fastener 212c is screwing. More specifically, the first fastener 212c comprises a screw 230a and a tapped hole 230b. The first frame 212a and the second frame 212b are attached or detached by the screw 230a screwed in or out the tapped hole 230b. Furthermore, the first fastener 212c can be a clutch, a claw, a sliding trough, a fastening trough or any other fastening structure. Moreover, the first frame 212a and the second frame 212b are assembled front-to-front, by sides or back-to-back.

FIG. 3B is a three-dimensional diagram of the assembled second frame module according to a preferred embodiment of the present invention. In FIG. 3B, the second frame module 220 uses the second fastener 222c to join the third frame 222a with the fourth frame 222b and to fix the optical films 224 in the optical film module 220. In one embodiment of the present invention, the second fastener 222c fastens the third frame 222a and the fourth frame 222b by clutching. Furthermore, the second fastener 222c can fasten the frames by screwing as shown in FIG. 3A. Of course, the second fastener 222c can be a claw, a sliding trough, a fastening trough or any other fastening structure that can join the third frame 222a with the fourth frame 222b. The fastening structure is not limited to the examples described in the present invention. Moreover, the third frame 222a and the fourth frame 222b are assembled front-to-front, by sides or back-to-back.

As described above, since the light source module 210 and the optical film module 220 are individual units, the light source module 210 and the optical film module 220 are capable of being assembled independently, thus increasing the efficiency of assembling. Moreover, the light source module 210 and the optical film module 220 can be repaired separately. More specifically, if the light source 214 is inoperative, only the light source module 210 is needed to be dismantled for repairing the light source 214. Since the optical film module 220 is not disassembled, the possibilities of damaging the optical films 224 or foreign particles entering into the optical films 224 are decreased. Similarly, if only the optical film 224 is inoperative, only the optical film module 220 is needed to be dismantled. In this way, the efficiency of maintenance is increased.

It is noted that the optical film module 220, as shown in FIG. 2, is detachably disposed on the light source module 210. In another embodiment of the present invention, the backlight module 200 further includes a third fastener (not shown) to assemble the light source module 210 with the optical film module 220. The third fastener is similar to the first fastener 212c or the second fastener 222c or any other fastener.

In summary, the light source module 210 and the optical film module 220 of the present invention are independently assembled and can be detachably joined, such that the assembling and the maintenance efficiency of the backlight module 200 of the present invention are increased.

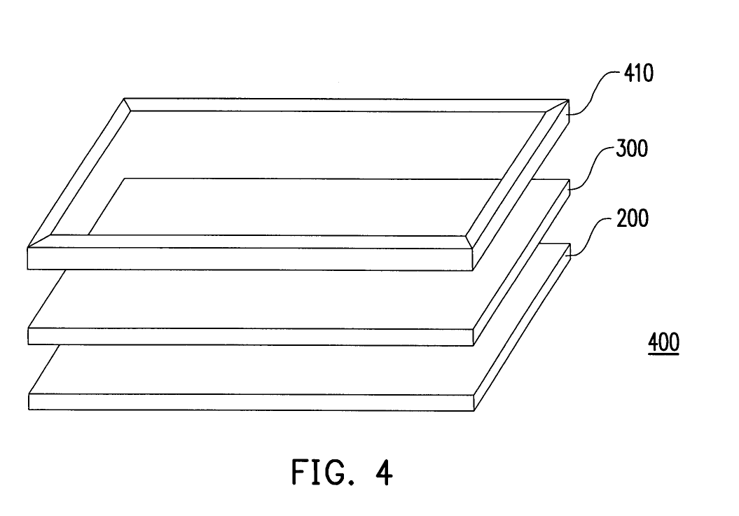

FIG. 4 illustrates a liquid crystal display according to a preferred embodiment of the present invention. In FIG. 4, the liquid crystal display 400 includes a backlight module 200 as described above and a liquid crystal display panel 300. The components and assembly of the backlight module 200 have been described above, and will not be repeated herein. The liquid crystal display panel 300 is disposed above the backlight module 200. The liquid crystal display panel 300 includes a TFT array substrate (not shown), a color filter substrate (not shown) and a liquid crystal layer (not shown) disposed between the two substrates. It should be noted that the liquid crystal display 400 as shown in FIG. 4 further includes an outer frame 410 for joining the backlight module 200 and the liquid crystal display panel 300.

For the liquid crystal display 400 employing the backlight module 200, the possibilities of damaging the optical films and external particles entering into the optical films are decreased, and the assembling and the maintenance efficiency is increased.

In summary, the backlight module and the liquid crystal display have the following advantages.

(a) The light source module and the optical film module are assembled independently and can be joined detachably, and therefore the assembling efficiency of the backlight module is increased.

(b) Even if one of the light source module and the optical film module is broken, only the broken part is needed to be disassembled, and hence the maintenance efficiency of the backlight module is increased.

(c) The disassembling steps are simpler for the backlight module of the present invention, to decrease the possibilities of damaging the optical films and external particles entering into the optical films.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A backlight module, comprising:
a light source module, comprising:
a first frame module; and
a light source disposed in the first frame module; and
an optical film module, comprising:
a second frame module; and
a plurality of optical films disposed in the second frame module;
wherein the optical film module is detachably disposed on the light source module.

2. The backlight module according to claim 1, wherein the first frame module comprises a first frame, a second frame and a first fastener, and the first frame is assembled with the second frame by the first fastener.

3. The backlight module according to claim 1, wherein the second frame module comprises a third frame, a fourth frame and a second fastener, and the third frame is assembled with the fourth frame by the second fastener.

4. The backlight module according to claim 1, further comprising a third fastener for joining the optical film module and the light source module.

5. The backlight module according to claim 1, wherein the light source further comprises a reflector disposed in the first frame module and on a back of the light source.

6. The backlight module according to claim 1, wherein the light source comprises one selected from the group consisting of a cold cathode fluorescent lamp, an external electrode fluorescent lamp, a light emitting diode and a flat fluorescent lamp.

7. The backlight module according to claim 1, wherein the optical films are selected from the group consisting of diffusion films, prism sheets and brightness enhancement films.

8. The backlight module according to claim 1, wherein a material of the first frame module is selected from the group consisting of plastics, metals and a combination thereof, and a material of the second frame module is selected from the group consisting of plastics, metals and a combination thereof.

9. A liquid crystal display, comprising:
a backlight module as recited in claim 1; and
a liquid crystal display panel disposed on the backlight module.

10. The liquid crystal display according to claim 9, wherein the first frame module comprises a first frame, a second frame and a first fastener, and the first frame is assembled with the second frame by the first fastener.

11. The liquid crystal display according to claim 9, wherein the second frame module comprises a third frame, a fourth frame and a second fastener, and the third frame is assembled with the fourth frame by the second fastener.

12. The liquid crystal display according to claim 9, further comprising a third fastener for joining the optical film module and the light source module.

13. The liquid crystal display according to claim 9, wherein the light source further comprises a reflector disposed in the first frame module and on a back of the light source.

14. The liquid crystal display according to claim 9, wherein the light source comprises one selected from the group consisting of a cold cathode fluorescent lamp, an external electrode fluorescent lamp, a light emitting diode and a flat fluorescent lamp.

15. The liquid crystal display according to claim 9, wherein the optical films are selected from the group consisting of diffusion films, prism sheets and brightness enhancement films.

16. The liquid crystal display according to claim 9, wherein a material of the first frame module is selected from the group consisting of plastics, metals and a combination thereof, and a material of the second frame module is selected from the group consisting of plastics, metals and a combination thereof.

17. The liquid crystal display according to claim 9, further comprising an outer frame for joining the backlight module with the liquid crystal display panel.
